(19) United States
(12) Patent Application Publication
(10) Pub. No.: US 2006/0278169 A1
(43) Pub. Date: Dec. 14, 2006

(54) Pet travel tubes

(76) Inventor: Chad Logan, Seal Beach, CA (US)

Correspondence Address: JAMES RAY & ASSOCIATES, 2640 Pitcairn Road, Monroeville, PA, 15146, US

(21) Appl. No.: 11/370,355

(22) Filed: Mar. 8, 2006

Related U.S. Application Data
(60) Provisional application No. 60/689,236, filed on Jun. 10, 2005.

(51) Int. Cl. A01K 5/01

(52) U.S. Cl. 119/61.56

(57) ABSTRACT

An apparatus for assisting in one of traveling and taking extended walks with a pet. The apparatus comprises a pair of elongated members having each of a predetermined cross section and a predetermined length. Each of the pair of elongated members being substantially hollow for storing at least one preselected item therein. Each of the pair of elongated members are divided to form at least two separate compartments in each of the pair of elongated members. There is a first means that is engageable with each respective end of each of the pair of elongated members for closing each respective end of each of the pair of elongated members. Further, there is a second means engageable with a predetermined portion of each of the pair of elongated members for carrying the pair of elongated members.

### CROSS REFERENCE TO RELATED APPLICATIONS

This application is closely related to and claims benefit from U.S. Provisional Application Ser. No. 60/689,236 filed Jun. 10, 2005.

The invention taught in this patent application is closely related to the invention taught in the following co-pending patent application, DOG TRAVEL TUBES, Ser. No. ______ which is being filed concurrently herewith. These patent applications are assigned to the same assignee and the teachings therein are incorporated into this application by reference thereto.

### FIELD OF THE INVENTION

The present invention relates, in general, to a travel aid and, more particularly, this invention relates to pet travel tubes for carrying items such as water and food for a pet while traveling.

### BACKGROUND OF THE INVENTION

People who travel with their pets or even take them for relatively long walks constantly are faced with the problem of having all of the necessary pet gear available. The needs may be somewhat different for those who are traveling by motorized vehicle for extended or even short trips as opposed to those just going on an extended walk, in that more gear may be necessary for those traveling by vehicles.

However, some of the gear that is required is common to whatever trip the pet will be taking, be it just walking or riding in a vehicle. Items such as water, leashes and waste disposal equipment are always a necessity regardless of how long the trip may be. Extended trips may also require food, toys, treats and other similar items. One problem that the pet owner encounters is that these items are easily misplaced and locating these items before each trip can not only be time consuming but often can be nerve racking. Another problem is where to carry these items while traveling. Placing them in a bag may be inconvenient because the bag may break while in use. Putting these items in a pocket is not possible.

Thus, it would be advantageous if these items could be kept in a convenient location where they would always be together without the need for searching for each item.

### SUMMARY OF THE INVENTION

The present invention provides an apparatus for assisting in one of traveling and taking extended walks with a pet. The apparatus comprises a pair of elongated members having each of a predetermined cross section and a predetermined length.

Each of the pair of elongated members being substantially hollow for storing at least one preselected item therein. Each of the pair of elongated members are divided to form at least two separate compartments in each of the pair of elongated members. There is a a first means that is engageable with each respective end of each of the pair of elongated members for closing each respective end of each of the pair of elongated members. Further, there is a second means engageable with a predetermined portion of each of the pair of elongated members for carrying the pair of elongated members.

### OBJECTS OF THE INVENTION

The present invention provides an apparatus for assisting in one in traveling and taking extended walks with a pet by storing necessary items therein.

Another object of the present invention is to provide an apparatus for carrying items needed for traveling with a pet such as water, food, waste disposal equipment, toys and leashes.

Still another object of the present invention is to provide an apparatus for carrying items needed for traveling with a pet that is easily carried.

Yet another object of the present invention is to provide an apparatus for carrying items needed for traveling with a pet where the items are secure.

An additional object of the present invention is to provide an apparatus for carrying items needed for traveling with a pet where the caps cans be used as water or food dishes.

In addition to the various objects and advantages of the present invention which have been described in detail above it should be obvious that those persons who are skilled in the relevant art can envision other objects and a advantages of the invention from the following more detailed description of the invention, particularly, when such description is taken in conjunction with the attached drawing Figures and with the appended claims.

### BRIEF DESCRIPTION OF THE DRAWINGS

FIG. 1 is a perspective view of an embodiment of the invention showing caps used of dishes.

FIG. 2 is a perspective view of an embodiment of the invention shown in FIG. 1 showing an opposite side.

FIG. 3 is a perspective view of an embodiment of the invention showing a design on the exterior of the apparatus.

FIG. 4 is a perspective view of an embodiment of the invention showing a different design on the exterior of the apparatus.

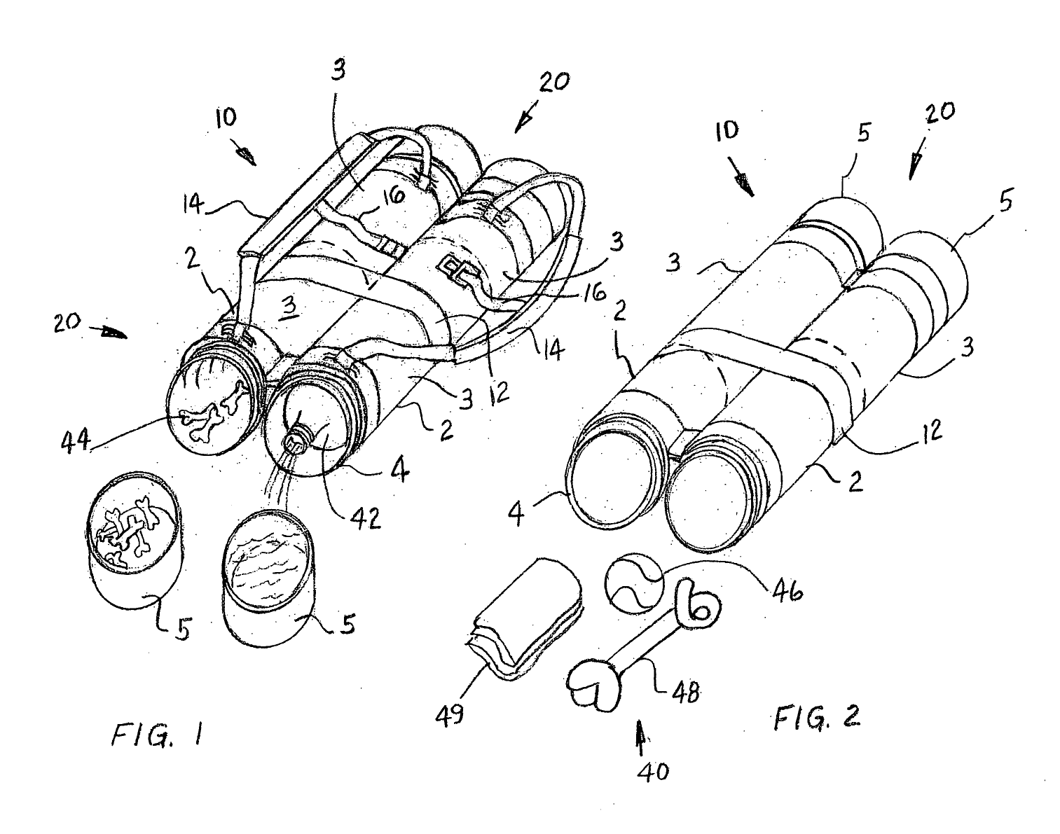

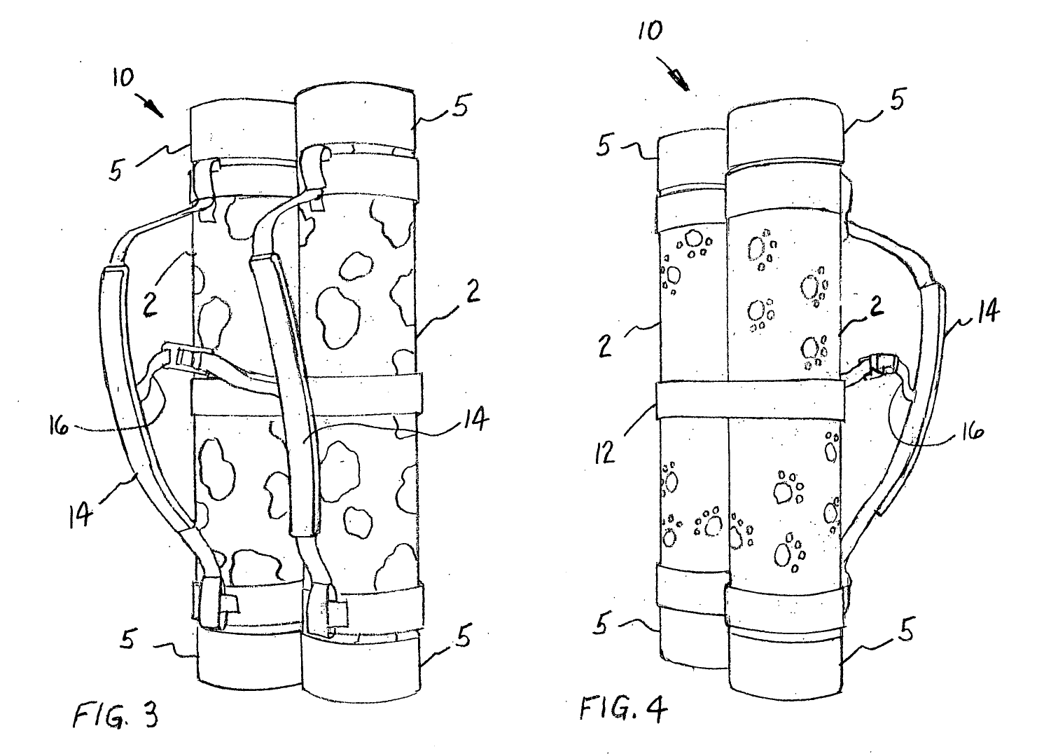

### BRIEF DESCRIPTION OF THE PRESENTLY PREFERRED AND VARIOUS ALTERNATIVE EMBODIMENTS OF THE INVENTION

Prior to proceeding to the more detailed description of the present invention it should be noted that for the sake of clarity and understanding of the invention identical components which have identical reference functions have been identified with identical reference numerals through out the several views illustrated in the drawings.

The present invention provides an apparatus, generally designated 10, for assisting in one of traveling and taking extended walks with a pet. The apparatus 10 comprises a pair of elongated members 2 having each of a predetermined cross section and a predetermined length.

Each of the pair of elongated members 2 being substantially hollow for storing at least one preselected item therein. Each of the pair of elongated members 2 are divided to form at least two separate compartments 3 in each of the pair of elongated members 2.

There is a first means, generally designated 20, that is engageable with each respective end 4 of each of the pair of elongated members 2 for closing each respective end 4 of each of the pair of elongated members 2. Further, there is a second means, generally designated 30, that is engageable with a predetermined portion of each of the pair of elongated members 2 for carrying the pair of elongated members 2.

Such pair of elongated members 2 are essentially a pair of elongated tubes 2. It is preferred that such tubes have a generally circular cross section and be generally in the shape of a pipe, however, such tubes could also have an octagonal, hexagonal cross section or any other similar shape. Such elongated tubes 2 are divided so as to form at least two compartments 3 in each elongated tube 2. The compartments can be used to carry such preselected items, generally designated 40, which would include water 42, food 44 or treats 44, balls 46, toys 48, leashes and waste disposable bags 49. One of such compartments 3 is designed to carry water 42 for such pet. This is a very important item since water is necessary if the pet is to go on extended walks or be in the automobile for any period of time. Another item that is virtually a necessity is waste disposal bags 49 and equipment such as a small hand shovel for picking up waste. The compartment 3 that is used to carry water 42 is a larger compartment 3 than the one used for waste disposal bags. The other two compartments 3 can be used to carry food and/or treats 44 and possibly toys 48 depending on the length of time the pet will be away from home. If it is just for an extended walk then may be treats would be preferred whereas if the trip is by vehicle and may be longer than food might be a preferred choice. Similarly, putting a leash or toys or both in the other compartment may depend on the length of the trip.

The apparatus 10 further includes a strap 12 for securing the pair of elongated tubes 2 together. Such strap 12 encircles the pair of tubes 2 to firmly hold them together.

Such second means 30 includes a pair of straps 14, each of the pair of straps 14 are engageable with a respective one of the pair of elongated tubes 2 for carrying the pair of tubes 2. These straps 14 are designed to fit over the shoulders so as to carry the apparatus 10 as a person would a backpack. Such straps 14 are adjustable so the person can adjust the apparatus 10 so that it is in a comfortable position. There is, further, another strap 16 which fits across a chest portion of the user connecting the two straps 14 together and securing them so that straps 14 don t slip off of the shoulder.

The first means 20 for closing each of the ends of the elongated tubes 2 is generally a cap 5. Such cap 5 can be affixed to the ends 4 of the elongated tubes 2 by means of threads. Such cap 5 could also be a snap on cap 5 which merely can snap on or off, or the cap 5 could also be secured to tube 2 by means of a friction fit. Such caps 5 can be used as a water dish or a food dish. That way the dish will always be available and one will not have to look for something to put water or food in when needed.

It is presently preferred that such pair of elongated tubes 2 are made of plastic. It is also preferred that such plastic is polyvinyl chloride.

While in accordance with the patent statutes a presently preferred embodiment of the invention has been illustrated in the attached drawing figures which have been described above, it should be obvious that various other modifications and alterations can be envisioned by those persons who are skilled in the relevant art without departing from the spirit of the invention.

I claim:

1. An apparatus for assisting in one of traveling and taking extended walks with a pet, said apparatus comprising:
(a) a pair of elongated members having each of a predetermined cross section and a predetermined length, each of said pair of elongated members being substantially hollow for storing at least one preselected item, said each of said pair of elongated members being divided to form at least two separate compartments in said each of said pair of elongated members;
(b) a first means engageable with each respective end of said each of said pair of elongated members for closing said each respective end of said each of said pair of elongated members; and
(c) a second means engageable with a predetermined portion of said each of said pair of elongated members for carrying said pair of elongated members.

2. The apparatus, according to claim 1, wherein said predetermined cross section of said pair of elongatged members is generally round.

3. The apparatus, according to claim 2, wherein said pair of elongated members are a pair of elongated tubes.

4. The apparatus, according to claim 1, wherein said at least one preselected item includes water, food, balls, toys, leashes and waste disposable bags,

5. The apparatus, according to claim 3, wherein one compartment of one of said pair of elongated tubes is designed to carry water for such pet.

6. The apparatus, according to claim 5, wherein another compartment of one of said pair of elongated tubes is designed to carry waste disposable bags for such pet.

7. The apparatus, according to claim 6, wherein said compartment designed to carry water is larger than said compartment designed to carry said waste disposal bags.

8. The apparatus, according to claim 3, wherein said apparatus further includes a strap for securing said pair of elongated tubes together.

9. The apparatus, according to claim 1, wherein said second means includes a pair of straps, each of said pair of straps engageable with a respective one of said pair of elongated members for carrying said pair of elongated members.

10. The apparatus, according to claim 9, wherein said pair of straps are shoulder straps for carrying said apparatus as a backpack.

11. The apparatus, according to claim 9, wherein said shoulder straps are adjustable.

12. The apparatus, according to claim 3, wherein said first means for closing said pair of elongated tubes is a cap.

13. The apparatus, according to claim 12, wherein said cap is secured to said pair of elongated tubes by at least one of threads, snap on and friction fit.

14. The apparatus, according to claim 12, wherein said is secured to said pair of elongated tubes by threads.

15. The apparatus, according to claim 12, wherein said cap is used to close each respective end of each of said pair of elongated tubes.

16. The apparatus, according to claim 3, wherein said pair of elongated tubes are made of plastic.

17. The apparatus, according to claim 16, wherein said plastic is polyvinylchloride.

18. The apparatus, according to claim 12, wherein at least one of said cap is used as one of a water dish and a food dish.

19. The apparatus, according to claim 1, wherein said pair of elongated members are made in a variety of colors.

20. The apparatus, according to claim 1, wherein said first means and said second means are made in a variety of colors.
